(19) United States
(12) Patent Application Publication
(10) Pub. No.: US 2006/0214458 A1
(43) Pub. Date: Sep. 28, 2006

(54) Spring system and vehicle seat having a spring system

(75) Inventors: Lutz Meyer, Kalletal (DE); Jens Ronnefahrt, Kalletal (DE)

Correspondence Address: GRAYBEAL, JACKSON, HALEY LLP, 155 - 108TH AVENUE NE, SUITE 350, BELLEVUE, WA, 98004-5901, US

(73) Assignee: ISRINGHAUSEN GmbH & Co. KG

(21) Appl. No.: 11/364,378

(22) Filed: Feb. 27, 2006

(30) Foreign Application Priority Data
Feb. 25, 2005 (DE) 102005008757.4-14

(51) Int. Cl. B60N 2/02

(52) U.S. Cl. 296/65.02

(57) ABSTRACT

The invention relates to a spring system having an oscillating part, a stationary part and an intermediately disposed air spring. At least one ccompressible pneumatic spring element is disposed between the stationary part and the oscillating part and defines an aperture through which the spring element is connected to the volume of the air spring, in an unloaded state, and the aperture is closed in a loaded, compressed state. The invention furthermore also relates to a vehicle seat which includes a spring system having the aforementioned features.

The invention relates to a spring system having an oscillating part, a stationary part and an intermediately disposed air spring, and to a vehicle seat having such a spring system.

In the case of sprung seats, limit stops of the spring system may be reached as a result of large excitation amplitudes. In order to reduce the load on the person seated on the vehicle seat when the limit stops have been reached, a hard end contact is softened in the spring system by appropriate stop buffers—such as, for example, rubber buffers. Such stop buffers have fixed physical properties—such as force-travel characteristic, self-damping, length and spring travel. A major disadvantage of this construction, however, is that there is no adaptation to the weight of the person seated on the vehicle seat.

It is therefore the object of the invention to provide a device by which a stop buffer is adapted to the weight acting on the spring system.

The object is achieved by a spring system having the features of claim 1 and by a vehicle seat having the features of claim 11. The aperture in the compressible pneumatic spring element provides for an exchange of the gas from the volume within the pneumatic spring element with the volume of the air spring. In this unaltered state, the spring system thus operates like any known spring system having a conventional air spring. Since, in the loaded, compressed state the aperture is closed, upon a predefined approach towards the end stop of the air spring the volume within the pneumatic spring element is isolated from the volume of the air spring. Upon a further approach towards the end stop, the volume of the pneumatic spring element becomes compressed, such that the action of the force of the spring element sets in. The force opposing the motion of the entire spring system is then adapted, in the case of a defined travel, to the moved mass. The moved mass in this case is the mass present on the vehicle seat in which the spring system is disposed. This results from the fact that, for an equal travel, the volume of the spring element is reduced by a defined amount. The force resulting from the compression in this case is proportional to the outgoing pressure. As a result, an end-stop buffer that is automatically adapted to the moved mass can thus be realized by this construction.

An advantageous development of the invention makes provision whereby the oscillating part is connected to an actuating element for the purpose of closing the aperture. The pneumatic spring element can thereby be connected to the stationary part of the spring system, and need not be continuously moved together with said spring system.

A further advantageous development of the invention makes provision whereby the spring element is disposed within the air spring. The space which is occupied by the air spring in any case is thereby optimally occupied, and the pneumatic spring element does not take away additional space at another location. A very compact embodiment is thus achieved. In this case, the spring element is preferably firmly connected to the part of the air spring that is connected to the stationary part of the spring system.

A further advantageous development of the invention makes provision whereby the volume of the spring element is connected, via an overflow line in which a throttle is provided, to the volume of the air spring or of the atmosphere. On the one hand, there is effected a strong compression of the gas within the pneumatic spring element, such that the spring characteristic becomes steeper, whilst, on the other hand, a small portion of the gas continues to overflow via the throttle and thereby takes energy out of the pneumatic spring element, resulting in a damping of the oscillation. An excellent combination of damping and spring action is thus achieved as a result.

A further advantageous development of the invention makes provision whereby the spring element is realized as a ball of an elastically deformable and pressure-resistant material, particularly of a plastic or to rubber. Such an embodiment can be produced very simply and inexpensively, and fulfils the requirements in an excellent manner. The aperture in this case is preferably realized on the upper side of the ball, and the ball itself is firmly connected, on its lower side, to the air spring. In particular, in this case the actuating element is disposed on the movable part of the air spring that is connected to the oscillating part, and is of a form that is suitable for closing the aperture of the ball.

A further advantageous development of the invention makes provision whereby the actuating element is realized as a rubber buffer. As a result, even in the case of complete compression of the pneumatic spring element, the final end stop is still not yet reached, since the actuating element can then also deform further. For this purpose, the material of the actuating element must be matched to the material of the pneumatic spring element.

A further advantageous development of the invention makes provision whereby the spring element is realized as a pneumatic cylinder. Such an element is well known from the prior art, and has long been used as a reliable element. Achieved thereby is a reliable embodiment of the invention which may also be disposed entirely outside of the air spring provided that it is connected to the volume of the air spring via a line.

Advantageous developments of the invention are explained more fully with reference to the exemplary embodiments represented in the figures, wherein:

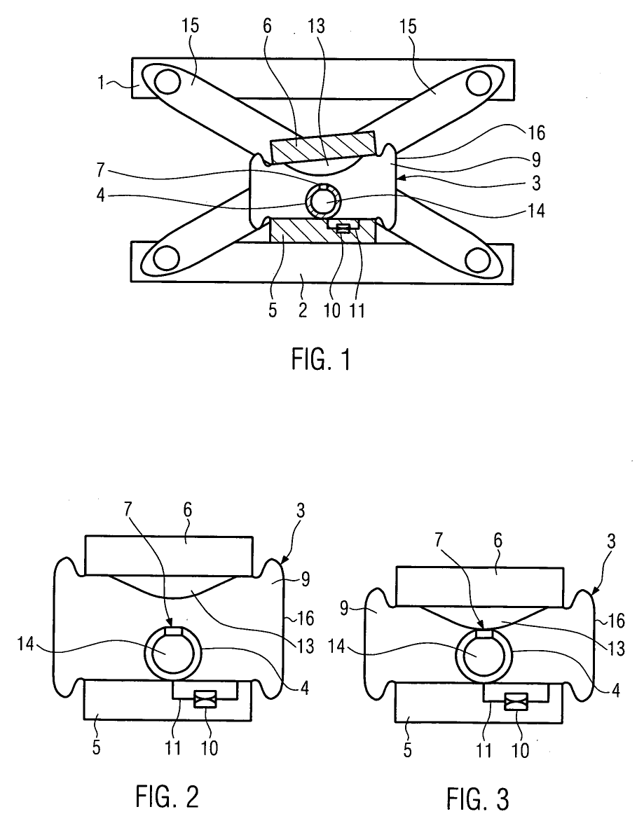

FIG. 1 shows a schematic section through a first exemplary embodiment of a spring system according to the invention,

FIG. 2 shows the air spring from FIG. 1, in the unloaded state,

FIG. 3 shows the air spring of FIG. 1, in the loaded state, and

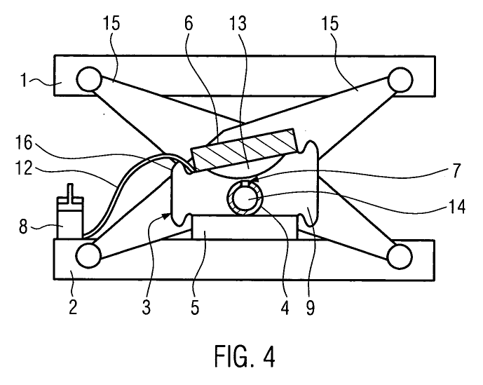

FIG. 4 shows a schematic section through a second exemplary embodiment of a spring system according to the invention.

FIGS. 1 to 3 shows a first air spring 3 according to the invention, having a pneumatic spring element 4, according to the invention, in different load states, the complete spring system according to the invention being represented schematically, around the air spring 3, in FIG. 1. Consequently, the following description relating to FIG. 1 is limited purely to the arrangement of the individual elements, the functioning then being described with reference to the two different load states of the air spring 3 in FIGS. 2 and 3.

The first exemplary embodiment of a spring system according to the invention, represented in FIG. 1, may be integrated, for example, into a vehicle seat. The spring system is known in principle from the prior art, the following making only brief reference to its realization unless it is directly essential to the invention.

A stationary part 2, which is usually connected to the base of a driver's cab, is connected to an oscillating part 1 via scissor-shaped connections 15. An air spring 3 is disposed between the stationary part 2 and the oscillating part 1. The air spring 3 has a fixed part 5, which is directly connected to the stationary part 2 of the spring system. Furthermore, the air spring 3 has a movable part 6, which is indirectly connected to the oscillating part 1 of the spring system via one of the scissor-shaped connections 15. The fixed part 5 is connected to the movable part 6 via a spring bellows 16, such that, a variable volume 9 is constituted.

Disposed within this volume 9 of the air spring 3 is a compressible pneumatic spring element 4. In the case represented, said spring element is a ball. The material of the ball is elastically deformable and pressure-resistant; advantageously, it is also resistant to ageing. The ball is thus preferably of a suitable plastic, particularly a polyurethane-elastomer—for example, a thermoplastic polyurethane (TPU)—or of rubber—a reinforced rubber is also possible in this case. On its lower side, the pneumatic spring element 4 is firmly connected to the fixed part 5 of the air spring 3. At its upper end, the pneumatic spring element 4 has an aperture 7. The wall of the ball-shaped pneumatic spring element 4 delimits a volume 14. The volume 14 of the spring element 3 is connected to the volume 9 of the air spring 3 via an overflow line 11 in which is inserted a throttle 10.

Here, both the overflow line 11 and the throttle 10 are disposed fully within the fixed part 5. This is by no means imperative, however, these two elements also being able to be located within the volume 9 of the air spring 3.

The movable part 6 is composed of, for example, a polyamide or an acrylonitrile-butadiene-styrene (ABS), or of another impact-resistant plastic, and is so shaped that it can close the aperture 7 of the pneumatic spring element 4.

The portion from FIG. 1 represented in FIG. 2 shows the air spring 3 with its associated elements in a position in which said air spring is not loaded. In this position, the volume 14 of the pneumatic spring element 4 is connected, via the aperture 7, to the volume 9 of the air spring 3. Upon loading of the spring system, the movable part 6 is compressed downwards. As a result, the volume 9 of the air spring 3 is reduced, whereas the volume 14 of the pneumatic spring element remains the same. The aperture 7 continues to provide for an exchange of gas between the volume 14 of the pneumatic spring element 4 and the volume 9 of the air spring 3. By contrast, no gas flows via the overflow line 11 from the volume 14 of the pneumatic spring element 4 into the volume 9 of the air spring 3, since this is prevented by the throttle 10.

If the spring travel has become so great that the actuating element 13 comes into contact with the pneumatic spring element 4, the situation represented in FIG. 3 is attained. In this loaded state of the air spring 3, the actuating element 13 obstructs the aperture 7 in the pneumatic spring element 4. Consequently, from this instant, it is no longer possible for gas to be exchanged between the volume 14 of the pneumatic spring element 4 and the volume 9 of the air spring 3 via the aperture 7. The pneumatic spring element 4 functions as a pneumatic end-stop buffer.

Upon a further compression of the air spring 3, the initially ball-shaped pneumatic spring element 4 becomes compressed. In this case, the volume 14 is reduced and the gas present therein is compressed. This produces a steeper spring characteristic. The force opposing the motion of the system, for a defined travel, is in this case matched to the moved mass since, for an equal travel, the volume of the pneumatic spring element 4 is reduced by a defined amount. The force resulting from the compression is in this case proportional to the outgoing pressure. An end-stop buffer that is automatically matched to the moved mass is thus achieved.

A small portion of the gas present in the volume 14 of the pneumatic spring element 4 escapes, via the overflow line 11 and the throttle 10 disposed therein, into the volume 9 of the spring element 3. This overflowing gas removes a portion of the energy from the pneumatic spring element 4, resulting in a damping of the oscillation. There is thus achieved a combined system which, on the one hand, serves as a spring element and, on the other hand, also continues to function as a damping element at the same time.

If the movable part 6 of the air spring 3 moves back upwards, beyond a predetermined point the aperture 7 reopens, since the actuating element 13 is no longer in contact with the pneumatic spring element 4.

Instead of having the overflow line 11 terminating in the volume 9 of the air spring 3, it is also possible for said overflow line to be routed outwards into the atmosphere.

It is also conceivable for the gas overflowing out of the volume 14 of the pneumatic spring element 4 to be collected in a separate receptacle.

FIG. 4 shows a second exemplary embodiment which has a total of two pneumatic end-stop buffers. On the one hand, the pneumatic spring element 4, represented in FIGS. 1 to 3 and described in detail above, is disposed within the volume 9 of the air spring 3. In contrast with the first exemplary embodiment, however, said spring element 4 does not have an overflow line 11 with a throttle 10. Otherwise, the functioning is the same as that described above.

Moreover, a second pneumatic end-stop buffer is provided outside of the air spring 3. In this case, said end-stop buffer is a pneumatic cylinder 8 which is firmly connected to the stationary part 2 of the spring system. The working volume of the pneumatic cylinder 8 is connected, via a connecting line 12—in which there is incorporated a throttle device, not shown—to the volume 9 of the air spring 3. Beyond a predefinable spring travel, the oscillating part 1 actuates the pneumatic cylinder 8, such that the working volume of the pneumatic cylinder 8 is reduced. The force to compress yet further the working volume of the pneumatic cylinder 8 then increases greatly. Although a portion of the gas of the working volume escapes from the pneumatic cylinder 8 into the volume 9 of the air spring 3, owing to the throttling in the connecting line 12 this is only such that energy is taken out of the pneumatic cylinder 8, which thus also has a damping property in addition to its resilient property.

### LIST OF REFERENCES

1 Oscillating part
2 Stationary part
3 Air spring
4 Pneumatic spring element
5 Fixed part
6 Movable part
7 Aperture
8 Pneumatic cylinder
9 Volume of the air spring
10 Throttle
11 Overflow line
12 Connecting line
13 Actuating element
14 Volume of the spring element
15 Scissor-shaped connection
16 Spring bellows

What is claimed:

1. A spring system having an oscillating part, a stationary part and an intermediately disposed air spring,
characterized in that
there is disposed between the stationary part and the oscillating part at least one compressible pneumatic spring element which has an aperture through which said spring element is coupled to the volume of the air spring, in an unloaded state,
and the aperture is closed in a loaded, compressed state.

2. A spring system according to claim 1, characterized in that the oscillating part is connected to an actuating element for the purpose of closing the aperture.

3. A spring system according to claim 1, characterized in that the spring element is disposed within the air spring.

4. A spring system according to claim 1, characterized in that the spring element is firmly connected to a fixed part of the air spring, which fixed part is connected to the stationary part of the spring system.

5. A spring system according to claim 1 4, characterized in that the volume of the spring element is connected, via an overflow line in which a throttle is provided, to the volume of the air spring or to the atmosphere.

6. A spring system according to claim 1, characterized in that the spring element comprises a ball of an elastically deformable and pressure-resistant material.

7. A spring system according to claim 6, characterized in that the aperture is positioned on the upper side of the ball, and said ball is firmly connected, on its lower side, to the air spring.

8. A spring system according to claim 7, characterized in that an actuating element is disposed on a movable part of the air spring that is connected to the oscillating part, and operates to close the aperture of the ball.

9. A spring system according to claim 2, characterized in that the actuating element comprises a rubber buffer.

10. A spring system according to claim 1, characterized in that the pneumatic spring element comprises a pneumatic cylinder.

11. A vehicle seat having a spring system according to any one of the preceding claims.
